(19) United States
(12) Patent Application Publication
(10) Pub. No.: US 2020/0044872 A1
(43) Pub. Date: Feb. 6, 2020

(54) APPARATUS AND METHOD FOR GENERATING PHYSICALLY UNCLONABLE FUNCTIONS

(71) Applicant: Fraunhofer-Gesellschaft zur Foerderung der angewandten Forschung e.V., Munich (DE)

(72) Inventors: Benjamin WILLSCH, Duisburg (DE); Stefan DREINER, Duisburg (DE)

(21) Appl. No.: 16/529,419

(22) Filed: Aug. 1, 2019

(30) Foreign Application Priority Data
Aug. 1, 2018 (DE) 10 2018 212 833.2

(51) Int. Cl. H04L 9/32

(52) U.S. Cl. CPC H04L 9/3278

(57) ABSTRACT

An apparatus for determining one or several response bits includes a hardware element comprising a plurality of parameters, and a determination module for determining one or several response bits. The determination module is configured to perform the determination of each response bit of the one or several response bits depending on one or several challenge bits. In addition, the determination module is configured to determine each of the one or several response bits by means of one or several selection processes, wherein the determination module is configured to, in each selection process of the one or several selection processes, perform a selection of a parameter from two or several parameters of the plurality of parameters of the hardware element. Here, the determination module is configured to perform the selection of the parameter from the two or several parameters depending on a challenge bit of the one or several challenge bits.

### CROSS-REFERENCE TO RELATED APPLICATION

This application claims priority from German Patent Application No. DE 10 2018 212 833.2, which was filed on Aug. 1, 2018, and is incorporated herein in its entirety by reference.

### BACKGROUND OF THE INVENTION

The application relates to an apparatus and a method for generating physically unclonable functions.

Physically unclonable functions (PUFs) are hardware-based, cryptographic primitives that generate a chip-specific secret from the manufacturing-related variation of nominally identical physical parameters. In cryptography, a primitive refers to an elementary building block that is part of a higher-level complex cryptographic system. The secret is typically present in the form of one or more binary raw keys which are used after potential post-processing to identify a chip or to generate cryptographic keys.

The literature distinguishes between different PUF types, i.e., between weak PUFs and strong PUFs, cf. [1]. The main differentiator is the number of different keys that may be extracted from a PUF.

In the case of a weak PUF, the number of possible keys scales polynomially with the area of the PUF. For this reason, the number of keys is typically limited to one secret key which is used, for example, as a random seed in public-key encryption processes or for encrypting sensitive data stored on-chip. Coding, which may be carried out by means of a cryptographic hash function, for example, is needed to guarantee the secrecy of the key in the case of an external query.

Strong PUFs enable the generation of a large number of different keys. Ideally, the number of keys increases exponentially with the number of characteristic values of a system that determine the state of a PUF and therefore determine the key generation process. In general, all applications of a weak PUF may be realized using a strong PUF. Due to the large number of keys, strong PUFs additionally have the advantage that they may be employed for challenge-response authentication concepts (cf. [1]).

Such concepts are implemented by transmitting to the PUF a so-called challenge that puts the PUF in a challenge-specific internal state. The state-dependent key that is output as a response to a given challenge serves for authenticating the PUFs. The challenge-response pairs (CRPs) may be exchanged publically if the CRPs are not reused after announcement. The public transmission of the CRPs has the advantage that the responses do not have to be encoded, meaning that apparatuses for on-chip encryption may be omitted.

The following describes characteristics of strong PUFs.

The security level provided by a PUF design for security-critical applications is determined by the randomness, uniqueness and stability of the generated responses, cf. [2]. In the case of strong PUFs, the challenge-response behavior should additionally fulfil the strict avalanche criterion (SAC), cf. [3], and should be resistant against modelling attacks.

The term randomness means that the physical PUF structures used for generating a response provide random response values for a given challenge due to process variations with repeated manufacturing.

The randomness of a response bit is determined by the probabilities according to which the events “response bit is a logical 0” and/or “response bit is a logical 1” occur. A high degree of randomness is given when both events are equally likely. In quality terms, the randomness of the response bits determines a predictability of a response. A random generation of the response bits ensures that an attacker is statistically unable to guess the correct bit sequence of a response or to derive it from the knowledge of other responses.

To uniquely identify a large number of PUF instances based on their CRPs, the responses need to differ in a sufficient number of response bits. This is referred to as uniqueness. Quantitatively, uniqueness is measured by the number of different response bits, the so-called inter-Hamming distance, whose distribution may be empirically determined from the pair-by-pair comparison of a multitude of responses. In the ideal case of completely randomly generated response bits, the distribution of the inter-Hamming distance follows a binomial distribution B(n; p=0.5; q), indicating the probability that two responses of the length n differ in exactly q bits. The expected value of the binomial distribution is n/2, i.e., with a random response generation, the responses differ on average by half of the key bits. In the case of strong PUFs, the keys of a given PUF instance also need to differ for different challenges. The latter requirement ensures that a previously used public key may not be used by an attacker to re-authenticate a PUF instance.

The stability of a response generally refers to the reproducibility of the response bits upon repeated response generation. Since the response generation of most PUF designs is based on the quantization of electrical parameters, disturbance variables such as thermal noise or Shot noise may cause a random change of a response bit. Other factors negatively affecting the response stability include temperature changes, fluctuations in the supply voltage, and aging of the PUF structures. Due to the physical implementation of a PUF, said interfering sources usually may not be avoided. Consequently, an important object in creating a PUF design is to minimize the negative influence of the interfering sources on the stability of the response generation.

Cryptographic functions that translate plain text into an encoded output should ideally have the property that each input bit passed on to the function affects all output bits. Ideally, changing an input bit causes the change of each output bit with a change probability of 50%. Functions having this property fulfil the so-called strict avalanche criterion, cf. [4].

In the case of a strong PUF, the strict avalanche criterion states that, when changing a bit of any challenge, each response bit changes with a probability of 50% cf. [3].

An essential property is the resistance against modelling attacks. Publically announced CRPs contain implicit information on the bit-generation process of a strong PUF instance. This information may be used by an attacker to model the internal structure of a strong PUF and to emulate the challenge-response behavior based on this model. The goal of such a modelling attack is to extract a model that may predict the response to a new randomly selected challenge with a high probability of success from as small a number of observed CRPs as possible. In practice, a strong PUF is resistant to feasible modelling attacks if, measured by the readout time of the CRPs and the model training time for modeling, a high number of CRPs is needed. The minimum number of CRPs needed for creating a model by means of machine learning may be determined, for example, in the context of the probably approximately correct (PAC) framework [5]. In order to generate a model that assigns with a probability of 1-δ (0<δ<0,5) the correct response to a new randomly selected challenge with a maximum error rate of 1-ε(0<ε<0,5), at least

$$m ( δ , ɛ , C ) = O ( \frac{1}{ɛ} log \frac{1}{δ} + \frac{VCdim ( F )}{ɛ} )$$

CRPs are needed. In the equation, F denotes the concept class to be learned and VCdim(F) denotes the Vapnik-Chervonenkis dimension of F, cf. [6]. The Vapnik-Chervonenkis dimension is a measure of the complexity of the model to be learned and, in the case of the considered strong PUF concepts, it determines the order of magnitude of the CRPs needed and therefore the modelability of a PUF design.

Thus, a strong PUF design should comprise the above described properties. Consequently, the challenge-response behavior of the strong PUF design should be random, specific for a given PUF instance and sufficiently stable against environmental influences. Furthermore, the strict avalanche criterion should be fulfilled and the challenge-response behavior should not be predictable by modelling attacks.

Existing state-of-the-art solutions may be divided into two categories, i.e., native strong PUF designs, and weak PUFs with an extended challenge-response space.

In the case of native strong PUF designs, the challenge-response behavior is implemented using hardware. Typically, a stimulus, e.g., in the form of an electrical signal, is applied to a series of serially connected structures of a PUF system, and the final state after propagation of the stimulus is measured. The passage through the individual structures modulates the input signal, wherein the modulation depends on the state of the PUF system, which is determined by intrinsic device-specific manufacturing fluctuations and the extrinsically-applied challenge. The strong PUFs illustrated in the following are designs that have been thoroughly investigated in the literature.

An arbiter PUF, as described in [7], consists of two symmetrically arranged signal paths that are led through a series of N serially-connected switch blocks. Passing a signal through both paths leads to a race condition which is caused by manufacturing-related delays of the switch blocks. The accumulated run time difference after passage of the signal is converted into a response bit using an arbiter. Through configuring the switch blocks by means of a challenge, an exponential number of challenge-response bit pairs may be extracted from an arbiter PUF. To obtain a M bit response, several arbiter PUFs may be operated in parallel, or one arbiter PUF may be evaluated M times with different challenges.

Due to the linear dependence of the response bit on the run time differences of the individual switch blocks, the strict avalanche criterion cannot be met. As shown in [3], for a 64-bit challenge arbiter PUF, at least 20 but no more than 40 bits of a challenge have to be changed on average so that the change probability is between approximately 40% and 60%.

Another consequence of the linearity is the susceptibility of the arbiter PUF with respect to modelling attacks. As shown in [8], arbiter PUFs may be efficiently modeled by means of machine learning. In the case of a 128-bit challenge arbiter PUF, a model of the challenge-response behavior that predicts the correct response to a new randomly selected challenge with a probability of 99.9% could be created from 39.2×10³ observed CRPs.

In order to increase the complexity of the challenge-response behavior and therefore the resistance against modelling attacks, different variations of the arbiter PUFs have been designed.

One variation is the feed-forward arbiter design which uses one or several coupled switch blocks, cf. [7]. The configuration of the additional switch blocks is coupled to the run time difference of the input signal which is tapped after a partial passage of the switch block chain.

Despite inserted non-linear elements, the feed-forward arbiter PUFs design may be emulated with the help of modelling attacks. For example, for a 64-bit challenge feed-forward arbiter PUF with 8 feed-forward blocks, a model of the challenge-response behavior that predicts a correct response to a new randomly selected challenge with a probability of 95.5% could be created from 50×10³ observed CRPs. The number of the feed-forward blocks is limited by the decrease of the response stability with each additional block, cf. [8].

Another variation of arbiter PUF provides that the response bits of two or more arbiter PUFs are linked by XOR operations, cf. [9], which is referred to as XOR arbiter PUF. Studies in [8] have shown that the number of challenges needed for a successful modelling attack increases exponentially in the number of the XOR-linked PUFs. The stability of the responses is a limiting factor for the number of XOR links. Experimental results in [10] indicate an exponential decrease of the response stability. Theoretical considerations, cf. [5], indicate that XOR arbiter PUFs are machine-learnable for any feasible number of XOR links (12) due to an increasing response instability and an increasing space requirement. If the responses show a slight instability, which is the case in practice due to the physical nature of a PUF, the modelling attack presented in [11] may be performed, which may emulate XOR PUFs with any number of XOR links.

The lightweight-secure PUF design, cf. [3], consists of several, parallely operating arbiter PUFs whose challenges and responses are linked. Fulfilling the strict avalanche criterion is achieved by a transformation of the challenge determining in a hard-wired manner the assignment of the challenge bits to the switch blocks of the different arbiter PUFs. In the case considered in [3], the realization needs at least 8 arbiter PUFs. In order to increase the resistance against modelling attacks, the response bits of the arbiter PUFs are linked with XOR operations according to an assignment rule. As shown in [8], lightweight-secure PUF designs may be emulated for up to 5 XOR links using modelling attacks. Since the structure and model equations are similar to those of the XOR arbiter, it may be assumed that the stability-based modelling attack in [11] may also be transferred to the lightweight-secure PUF. In this case, designs with more than 5 XOR links may also be modeled.

The design of the bistable-ring PUF, cf. [12], consists of annularly linked segments, each consisting of two NOR gates. The inputs and outputs of the NOR gates are connected to a MUX (multiplexer) each. For generating a bit, the ring is excited to oscillate and the state at one of the segments is measured after a predetermined duration. As in the case of the arbiter PUF, the bistable-ring PUF uses manufacturing-related run time fluctuations of the logic gates to generate a response bit. The generated response bit depends on the selected challenge which determines the configuration of the MUXs in the chain segments.

Theoretical considerations, cf. [13], and experimental results, cf. [14], have shown that the CRP behavior is dominated by a few challenge bits, as a result of which the strict avalanche criterion is not met.

The presence of dominant challenge bits could be successfully used to perform modelling attacks, cf. [13]. XOR-based variations of the bistable-ring PUF, in which the response bits of several bistable-ring PUFs are linked to XOR operations, could currently be emulated for up to 3 XOR links, cf. [15].

The current mirror PUF design consists of a serially linked chain of parallely-connected current mirror pairs, each of which is driven by means of a multiplexer, cf. [16]. To generate a response bit, a constant current is applied in both paths of the chain, and the current difference between the paths at the end of the chain is measured. Due to manufacturing-related fluctuations, the slope of the transfer characteristic curve of the individual current mirrors varies, as a result of which the measured current difference differs for nominally identical current mirrors. The configuration as to which current mirror contributes to which of the two current paths is carried out by means of an applied challenge.

As was experimentally demonstrated in [17], the security properties can be successfully emulated by means of modelling attacks despite the non-linear transfer behavior of the current mirror PUF.

In addition, weak PUFs with an extended challenge-response space are to be mentioned. Solutions of this section category follow an algorithmic approach to extend the challenge-response space of a weak PUF design. Extending the challenge-response space is typically performed by grouping and multiple comparison of selected PUF structures, wherein the grouping and the selection of the structures depend on the applied challenge. Since the possibility of the pair-by-pair comparison has to be given, the application of existing algorithms is limited to PUF designs whose bit generation is based on the pair-by-pair comparison of analog parameters. Due to this limitation, the use of existing solution concepts is not possible for a broad class of memory-based PUF designs (cf. [2]), such as the commercially distributed SRAM PUF.

The k-sum PUF design, described in [18], includes two chains each consisting of k ring oscillator pairs. The differences of the ring oscillator pairs are summed up for both chains and then the difference of the two sums is formed. The difference is converted into a response bit. A challenge of a length of k bits that is applied to the k oscillator pairs of both chains determines whether the respective pair difference enters into the sum with a positive or a negative sign.

Since the response bit linearly depends on the oscillation frequencies, the strict avalanche criterion is not fulfilled as in the case of the arbiter PUF. Due to the linear structure of the response generation, the same modelling attacks as for the arbiter PUF may be performed.

A ring oscillator PUF with an extended challenge-response space is also to be mentioned. The concept presented in [19] uses configurable pair differences of ring oscillators which are assigned to real-valued numbers Q by means of an identity-mapping function. The identity-mapping function comprises the following steps:

For a given challenge, m ring oscillators are selected. (ii) From the m ring oscillators, (2≤t≤m)

$$( \begin{matrix}m \\ t\end{matrix} )$$

oscillator frequencies are selected for each t and are combined to t sets of Sₜ.

For each set, a sum is formed through the root of the amount of pair-by-pair differences, wherein each addend is weighted with the Euclidean distance between the ring oscillators used. The value of the sum corresponds to the Q value. The quantized Q values are used as response.

A disadvantage is that the calculation of Q values for large m is computationally complex and the calculation of the identity-mapping function has to be performed on-chip. Additional logic blocks are needed for the calculation, resulting in an increased area and energy requirement.

In addition, the CPRs are statistically correlated, which may be used as a potential point of attack to compromise the security properties of the PUF. So far, no published modelling attacks are known, cf. [19].

Therefore, it is desirable to provide improved concepts for generating physically unclonable functions.

### SUMMARY

According to an embodiment, an apparatus for determining one or several response bits may have a hardware element including a plurality of parameters, and a determination module for determining one or several response bits, wherein the determination module is configured to perform the determination of each response bit of the one or several response bits depending on one or several challenge bits, wherein the determination module is configured to determine each of the one or several response bits by means of one or several selection processes, wherein the determination module is configured to, in each selection process of the one or several selection processes, perform a selection of a parameter from two or several parameters of the plurality of parameters of the hardware element, wherein the determination module is configured to perform the selection of the parameter from the two or several parameters depending on a challenge bit of the one or several challenge bits.

According to another embodiment, a method for determining one or several response bits may have the steps of: determining one or several response bits, wherein the determination of each response bit of the one or several response bits is performed depending on one or several challenge bits, wherein each of the one or several response bits is determined by one or several selection processes, wherein, in each selection process of the one or several selection processes, a selection of a parameter is performed from two or several parameters of the plurality of parameters of a hardware element, wherein the selection of the parameter from the two or several parameters is performed depending on a challenge bit of the one or several challenge bits.

Another embodiment may have a non-transitory digital storage medium having a computer program stored thereon to perform the method for determining one or several response bits, wherein the method may have the steps of: determining one or several response bits, wherein the determination of each response bit of the one or several response bits is performed depending on one or several challenge bits, wherein each of the one or several response bits is determined by one or several selection processes, wherein, in each selection process of the one or several selection processes, a selection of a parameter is performed from two or several parameters of the plurality of parameters of a hardware element, wherein the selection of the parameter from the two or several parameters is performed depending on a challenge bit of the one or several challenge bits, when said computer program is run by a computer.

An apparatus for determining one or several response bits is provided. The apparatus includes a hardware element comprising a plurality of parameters, and a determination module for determining one or several response bits. The determination module is configured to perform the determination of each response bit of the one or several response bits depending on one or several challenge bits (request bits). In addition, the determination module is configured to determine each of the one or several response bits by one or several selection processes, wherein the determination module is configured to, in each selection process of the one or several selection processes, perform a selection of a parameter from two or several parameters of the plurality of parameters of the hardware element. In this case, the determination module is configured to perform the selection of the parameter from the two or more parameters depending on a challenge bit of the one or several challenge bits.

In an embodiment, the hardware element may, for example, comprise a plurality of physically measureable parameters, and the determination module may, for example, be configured for determining the one or several response bits from the physical measurement values of these parameters.

Furthermore, a method for determining one or several response bits is provided. The method includes determining one or several response bits, wherein determining each response bit of the one or several response bits is performed depending on one or several challenge bits. Each of the one or several response bits is determined by one or several selection processes, wherein, in each selection process of the one or several selection processes, a selection of a parameter from two or several parameters of the plurality of parameters of a hardware element is performed, wherein the selection of the parameter from the two or several parameters is performed depending on a challenge bit of the one or several challenge bits.

Furthermore, a computer program having a program code for performing the above described method is provided.

### BRIEF DESCRIPTION OF THE DRAWINGS

Embodiments of the present invention will be detailed subsequently referring to the appended drawings, in which:

FIG. 1 shows an apparatus for determining one or several response bits according to an embodiment;

FIG. 2 shows a schematic illustration of a strong PUF concept according to an embodiment;

FIG. 3 shows a generic implementation of the strong PUF concept according to an embodiment, which is realized in the form of a single chain including N segments;

FIG. 4 shows a feedback for mixing the i-th portion of the first chain according to an embodiment;

FIG. 5 shows a feedback chain according to an embodiment, having four portions each including a chain segment;

FIG. 6 shows a feedback chain in a ring-shape according to an embodiment;

FIG. 7a-7d show the distribution of an inter-Hamming distance for the four primitives averaged over several PUF instances according to embodiments;

FIG. 8a-8d show inter-Hamming distances averaged over 10,000 randomly generated challenges according to embodiments;

FIG. 9 shows a transfer probability determined for 10,000 CRPs according to an embodiment;

FIG. 10 shows a probability P depending on the chain length according to an embodiment;

FIG. 11 shows a probability distribution of single chains according to an embodiment; and

FIG. 12 shows a probability distribution of the feedback chain and of a single chain according to an embodiment.

### DETAILED DESCRIPTION OF THE INVENTION

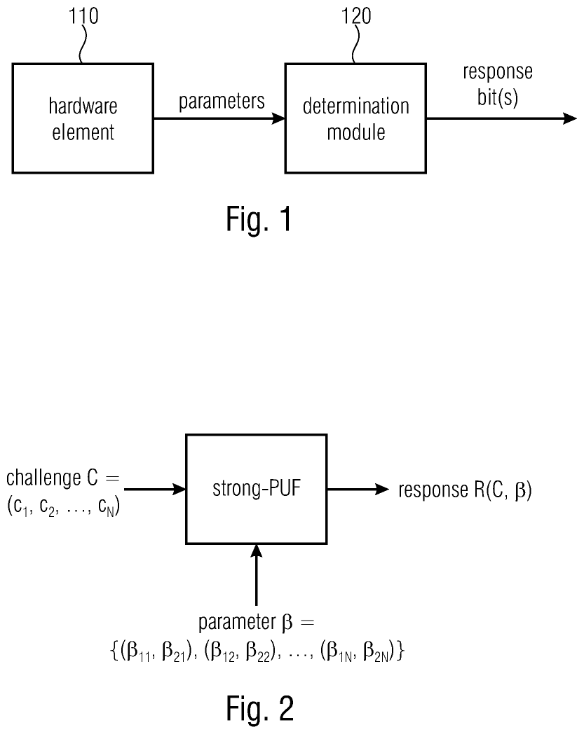

FIG. 1 shows an apparatus for determining one or several response bits according to an embodiment.

The apparatus includes a hardware element 110 comprising a plurality of parameters, and a determination module 120 for determining one or several response bits.

The determination module 120 is configured to perform the determination of each response bit of the one or several response bits depending on one or several challenge bits.

In addition, the determination module 120 is configured to determine each of the one or several response bits by one or several selection processes, wherein the determination module 120 is configured to, in each selection process of the one or several selection processes, perform a selection of a parameter from two or several parameters of the plurality of parameters of the hardware element 110.

In this case, the determination module 120 is configured to perform the selection of the parameter from the two or several parameters depending on a challenge bit of the one or several challenge bits.

According to an embodiment, for example, each parameter of the plurality of parameters of the hardware element 110 may be a physically measurable quantity or may have been determined from a physically measurable quantity.

In an embodiment, for example, the hardware element 110 may comprise a plurality of physically measureable parameters, and, for example, the determination module 120 may be configured for determining the one or several response bits from the physical measurement values of these parameters of the hardware element.

According to an embodiment, for example, at least one of the plurality of, e.g., physically measureable, parameters may depend on an electric voltage or on an electric current in the hardware element 110 or on an oscillation cycle of an oscillator in the hardware element 110.

In an embodiment, for example, the determination module 120 may be configured to perform the determination of each response bit of the one or several response bits depending on two or several challenge bits. In this case, for example, the determination module 120 may be configured to determine the one or several response bits by means of two or several selection processes, wherein the determination module 120 may be configured to, in each selection process of the two or several selection processes, perform the selection of the parameter from two or several parameters of the plurality of parameters of the hardware element 110, wherein the determination module 120 may be configured to perform the selection of the parameter from the two or several parameters depending on a challenge bit of two or several challenge bits.

According to an embodiment, for example, the determination module 120 may be configured to perform the selection of the parameter from the two or several parameters such that each selection process of the two or several selection processes depends on a different challenge bit of the two or several challenge bits.

In an embodiment, for example, each, e.g., physically measureable, parameter of the plurality of parameters may be present as a binary value which has been determined from one or several, e.g., physically measureable, values. In this case, for example, the determination module 120 may be configured to determine each response bit of the one or several response bits by means of the two or several selection processes such that the binary values of the two or more parameters that have been determined in the two or more selection processes are linked to one another via a XOR link in order to obtain the response bit.

According to an embodiment, for example, each, e.g., physically measurable, parameter of the plurality of parameters may be present as a numerical value, wherein the determination module 120 may, for example, be configured to determine a binary value for the parameter to the numerical value of each, e.g., physically measureable, parameter of the plurality of parameters by means of a comparison to a threshold value of a plurality of threshold values. In this case, for example, the determination module 120 may be configured to determine each response bit of the one or several response bits by means of the two or several selection processes such that the binary values of the two or several parameters that have been determined in the two or several selection processes are linked to one another by a XOR link to obtain the response bit.

In an embodiment, for example, the determination module 120 may be configured to determine each response bit of the one or several response bits by means of the two or several selection processes using the following equation:

$$R = {⊕}_{k = 0}^{N} ( {\overline{c}}_{k} {β}_{1 k} ⊕ {c}_{k} {β}_{2 k} )$$

wherein R may determine the response bit or an intermediate result for determining the response bit, wherein N determines a number of the two or several selection processes, wherein cₖ is a binary value of a challenge bit of the two or several challenge bits on which a k-th selection process of the two or several selection processes depends, wherein c̅ₖ is an inverted value of the challenge bit of the two or several challenge bits on which the k-th selection process of the two or several selection process depends, wherein β₁ₖ is the binary value of a first, e.g., physically measureable, parameter of the two or several parameters, and wherein β₂ₖ is the binary value of a second, e.g., physically measureable, parameter of the two or several parameters.

Thus, in an embodiment, for example, R may designate the response bit or, for example, an intermediate result for determining the response bit. Thus, for example, the specified formula may be used for determining the intermediate result. In an embodiment, for example, in a case of the feedback chain, a response bit may be generated from one or several intermediate results after further selection processes.

In an embodiment, for example, each, e.g., physically measureable, parameter of the plurality of parameters may be present as a numerical value. In this case, for example, the determination module 120 may be configured to determine each response bit of the one or several response bits by means of the two or several selection processes such that two or several parameters that have been determined in the two or several selection processes are multiplied with one another in order to obtain an intermediate result, wherein the determination module 120 is configured to compare the intermediate result to a threshold value in order to obtain the response bit.

In an embodiment, for example, the determination module 120 may be configured to determine the one or several response bits depending on two or more chains, wherein each of the two or more chains comprises two or more chain segments, wherein each of the two or more chain segments of the two or more chains is assigned to exactly one selection process of the two or more chains, wherein each chain segment of the two or more chains may comprise two or more, e.g., physically measureable, parameters of the plurality of parameters of the hardware element 110, respectively. In this case, for example, the determination module 120 may be configured to determine each of the one or several response bits by means of the two or several selection processes such that the determination module 120 is configured to, in each selection process of the two or several selection processes, select one chain of the two or more chains, wherein the determination module 120 is configured to determine the chain segment of the selected chain that is assigned to the selection process, and wherein the determination module 120 is configured to determine the response bit by selecting a parameter of the two or more parameters of the chain segment assigned to the selection process depending on the challenge bit of the two or several challenge bits.

According to an embodiment, for example, the determination module 120 may be configured to determine each of the one or several response bits by means of the two or several selection processes such that the two or several selection processes follow each other. In this case, for example, the determination module 120 may be configured to, in a current selection process of the two or several selection processes, determine the chain from the two or several chains depending on a selection process preceding the current selection process.

In an embodiment, for example, the determination module 120 may be configured for determining two or several response bits.

In an embodiment, for example, the hardware element 110 may be a transistor.

According to an embodiment, for example, the hardware element 110 may be a resistor.

In an embodiment, for example, the hardware element 110 may be an optical sensor.

According to an embodiment, for example, the hardware element 110 may be a re-programmable circuit, e.g., a field programmable gate array (FPGA).

The following describes embodiments that provide a generation of random challenge-response pairs.

Embodiments are based on the following basic concepts:

The plurality of existing strong PUF designs comprises three essential problems: (i) lack of complexity between response bits and the system-specific, e.g., physically measureable, parameters used for bit generation, (ii) dependency in magnitude of the response bits on these parameters, and (iii) a strong dependency of the performance on the concrete hardware implementation of a design. The first problem leads to a high susceptibility to modelling attacks. The second problem results in a low sensitivity of the response bits with respect to changes of the challenge bits and therefore in the non-fulfillment of the strict avalanche criterion. The last point holds difficulties to achieve a consistent security level with respect to the response randomness and uniqueness since these properties are determined by the manufacturing conditions (manufacturing line, technology, etc.) of a PUF. To this dependency, it is generally not possible to ensure that a strong PUF design comprises the same performance in the long term or achieves a similar security level as under manufacturing conditions already tested when transferred into a different manufacturing line/technology.

The solution approach of point (i) and (ii) followed in the literature consists in extending the designs by additional, non-linear elements. This type of complexity increase causes an exponentially increasing instability of the response bits as to disturbances such as noise or temperature changes, cf. [10]. The instability of the CRPs limits the maximum possible complexity of the link and provides a point of attack for modelling attacks which use the lack of reproducibility to reduce the complexity of the bit generation process, cf. [11]. Error correction methods for increasing the response stability may not be applied due to the high bit error rates. The manufacturing dependency stated under point (iii) is an unsolved problem in existing strong PUF designs. The common practice for verifying the performance of a strong PUF based on experimental examination proves to be an insufficient solution with respect to the security requirements for a cryptographic system used for the protection of sensitive data.

In order to solve the problems (i) and (ii), the strong PUF concept provided according to embodiments use a non-linear link of the parameters of a system whose output values do not depend on the magnitude of the parameters. The link is implemented in the form of simple logical operations which are exemplarily described for two embodiments of the PUF constructions in the following sections. Both constructions provably (see below) enable the generation of random, unique, and stable response bits which fulfil the strict avalanche criterion on average. In addition, one of the constructions comprises a high complexity against modelling attacks, which is easy to be scaled based on a characteristic value of design. With respect to problem (iii), a manufacturing-independent strong performance of the concept can be ensured by using the response bits of weak PUFs as input quantities for the strong PUF construction. In this case, the use of appropriate quantization methods (cf. [24]) or post-processing methods (error correction, key whitening by means of XOR chipped transformation, etc.) a manufacturing-independent generation of stable, random weak PUF responses whose properties are transferred onto the presented strong PUF construction.

The newly developed strong PUF construction according to embodiments is based on a link of signed or binary elements which are selected from a set of, e.g., physically measureable, characteristic value pairs β of a physical system. The elements of the characteristic values are selected by means of a challenge C. From the link of the selected elements of the characteristic value pairs, a response R of the system is derived which depends on the challenge and the incoming, e.g., physically measureable, characteristic values. The totality of all challenge-response pairs (C, R(C, β)) results in a characteristic challenge-response behavior for the system.

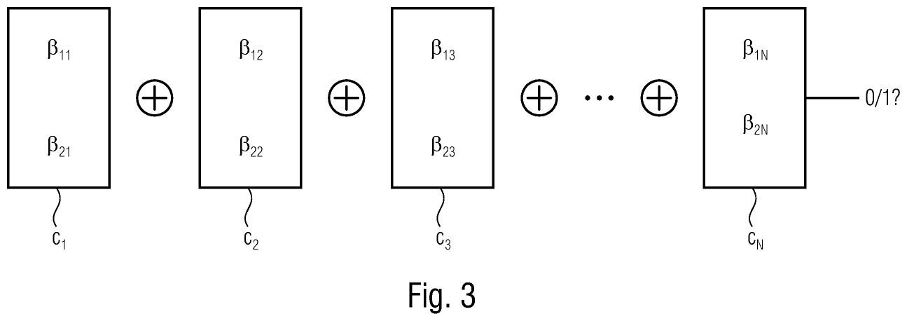

FIG. 2 shows a schematic illustration of the strong PUF concept according to an embodiment.

In the application case of a strong PUF, the characteristic values correspond to measureable parameters of a physical system whose signs or parity are/is randomly developed due to manufacturing fluctuations. For example, the parameters may be of real-valued, integer or binary nature. Real-valued parameters may, e.g., include electrical currents and/or voltages. An example for integer parameters is the number of oscillation cycles of a ring oscillator counted over a specified duration. In the case of positive values, signed parameters may be obtained by difference formation. For example, binary parameters may be derived from the state of logic components or memory components. Alternatively, non-binary parameters may be appropriately quantized (e.g., by comparison to a threshold value, etc.) to generate binary values.

In embodiments, linking the parameters is performed such that the result of the linking exclusively depends on the signs of the parameters and/or their parity. In the case of non-binary parameters, linking may, for example, be performed by multiplying the signs of the parameters. Binary parameters may be linked by means of logical operations, e.g., the logical XOR function (Exclusive OR). The latter form of linking results in the parity of the chained binary values. In the two stated examples, the response bit of the strong PUF results from the resulting sign and/or from the parity of the linked characteristic values.

In order to obtain challenge-dependent responses, the challenge may be used for selecting the parameters that contribute to the response generation. For example, the N challenge bits of a challenge with a length of N bits may determine which N elements from a set of parameters combined pair-by-pair are selected and linked. In this case, the value of the i-th challenge bit determines which element of the i-th pair of parameters is selected: for example, if the i-th challenge bit becomes a logical zero, the first element of the i-th pair of parameters is selected; with a logical 1, the second element of the i-th pair is selected.

The construction described generates one response bit per link and challenge. To obtain a response with a length of m bits, several links may be read out with the same challenge or a number of links may repeatedly be read out with different challenges. In the latter case, for example, several challenges may be generated using a linear-feedback shift register that is initialized by means of a (pseudo) randomly generated master challenge.

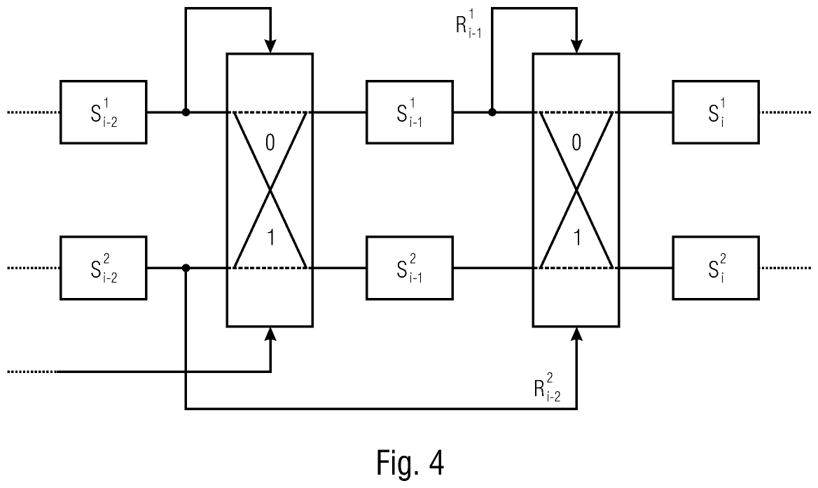

FIG. 3 shows a generic implementation of the strong PUF concept according to an embodiment realized in the form of a single chain including N segments.

The system for generating a response bit consists, for example, of N segments linked into a chain. The segments Sᵢ, i=1,2, . . . , N each consist of, for example, two independent non-binary signed or binary parameters (β₁ᵢ, β₂ᵢ). Linking is carried out multiplicatively in the case of non-binary parameters and by means of XOR operator in the case of binary parameters, for example. An N-bit challenge may be applied to the N segments of the chain. If the challenge bit cᵢ applied at the i-th segment of the chain corresponds to a logical 0 (cᵢ=0), the state of the segment is determined by the parameter β₁ᵢ.

For cᵢ=1, the parameter β₂ᵢ is selected.

The value of the response bit after passage of an N segment chain may be determined based on the following equation:

$$R = {⊕}_{k = 0}^{N} ( {\overline{c}}_{k} {β}_{1 k} ⊕ {c}_{k} {β}_{2 k} )$$

wherein c̅ₖ corresponds to the negated value of the k-th challenge bit.

### EXAMPLE

For a chain with N=4 Segments and binary parameters β={(β₁₁=0, β₂₁=0), (β₁₂=1, β₂₂=1), (β₁₃=0, β₂₃=1), (β₁₄=0, β₂₄=1)}, for example, the following challenge-response pairs (CRPs) result:

C₁=(0,1,0,0)→R₁=β₁₁⊕β₂₂⊕β₁₃ ⊕β₁₄=0⊕1⊕0⊕0=1

C₂=(0,1,1,1)→R₂=β₁₁⊕β₂₂⊕β₂₃ ⊕β₂₄=0⊕1⊕1⊕0=1

C₃=(0,1,0,1)→R₃=β₁₁⊕β₂₂⊕β₁₃ ⊕β₂₄=0⊕1⊕0⊕0=0

C₄=(0,0,0,0)→R₄=β₁₁⊕β₁₂⊕β₁₃ ⊕β₁₄=0⊕1⊕0⊕0=1

C₅=(0,0,1,1)→R₅=β₁₁⊕β₁₂⊕β₂₃ ⊕β₂₄=0⊕1⊕1⊕0=1

wherein Rₖ designates the response bit belonging to the k-th challenge Cₖ, and ⊕ corresponds to the logical XOR link. In the stated example, the challenges were written in the form C=(c₁, c₂, . . . , c_{N}).

The following describes a feedback chain according to an embodiment.

In order to increase the resistance against modelling attacks, two single chains are coupled to each other in portions, as a consequence of which the linked parameters of both chains are mixed. Coupling causes the mix of the parameters in the i-th portion of the first and second chains, respectively, to depend on the parities which are determined from the link of the preceding chain portions of chain 1 and chain 2, respectively.

For example, a simple form of intermixture in the i-th portion of the first chain may be caused by swapping the parameters between chain 1 and chain 2 in the same portion.

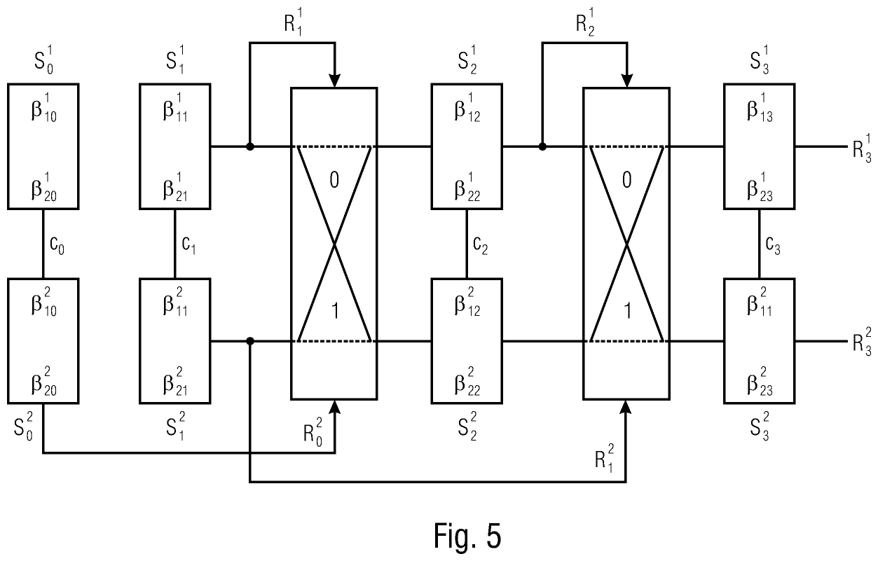

FIG. 4 shows a feedback for the intermixture of the i-th portion of the first chain according to an embodiment.

Swapping is carried out if the XOR link of the parity R¹ᵢ₋₁ of the first chain corresponds to a logical 1 up to the (i-1)-th portion and the XOR link of the parity R²ᵢ₋₂ of the second chain corresponds to a logical 1 up to the (i-2)-th portion. In this case, the parity S²ᵢ of the i-th portion of the second chain is linked to the parity R¹ᵢ₋₁ of the first chain. In the case of a logical 0, there is no swap, and the parity S¹ᵢ of the i-th portion of the first chain is linked to the parity R¹ᵢ₋₁ of the first chain, cf. FIG. 4. The intermixture of the second chain occurs analogously thereto.

Due to the swapping operations in each portion of the chain, 2^{M} combination possibilities of the parameters determining the value of the response bits R¹_{/} and R²_{/} of the chain result for M portions. Due to the coupling within and between the two chains, the resulting link of the parameters is characteristic for the selected challenge and the realization of the system used, which is defined by the incoming parameters.

The response bits R¹_{/} and R²_{/} of the first and second chain, respectively, after passage of the / first chain portions may be expressed in the form of coupled recursive equations:

Rₗ¹=Rₗ₋₁¹⊕(̅R̅ₗ̅₋̅₁̅¹̅⊕̅R̅ₗ̅₋̅₂̅²̅)̅Sₗ¹⊕(Rₗ₋₁¹⊕Rₗ₋₂²)Sₗ²

Rₗ²=Rₗ₋₁²⊕(̅R̅ₗ̅₋̅₁̅²̅⊕̅R̅ₗ̅₋̅₂̅¹̅)̅Sₗ²⊕(Rₗ₋₁²⊕Rₗ₋₂¹)Sₗ¹

with Rₗ^{j}=Sₗ^{j} for l=0, 1. In the stated equations

$${S}_{i}^{j} = {⊕}_{{k}_{i}} ( {\overline{c}}_{{k}_{i}}^{j} {β}_{1 {k}_{i}}^{j} ⊕ {c}_{{k}_{i}}^{j} {β}_{2 {k}_{i}}^{j} )$$

corresponds to the parity if the i-th portion of the j-th chain. The index tuple (kᵢ, j) designates the k-th segment of the i-th portion of the chain j (j=1, 2) and c̅ corresponds to the negation of the challenge bit c.

### EXAMPLE

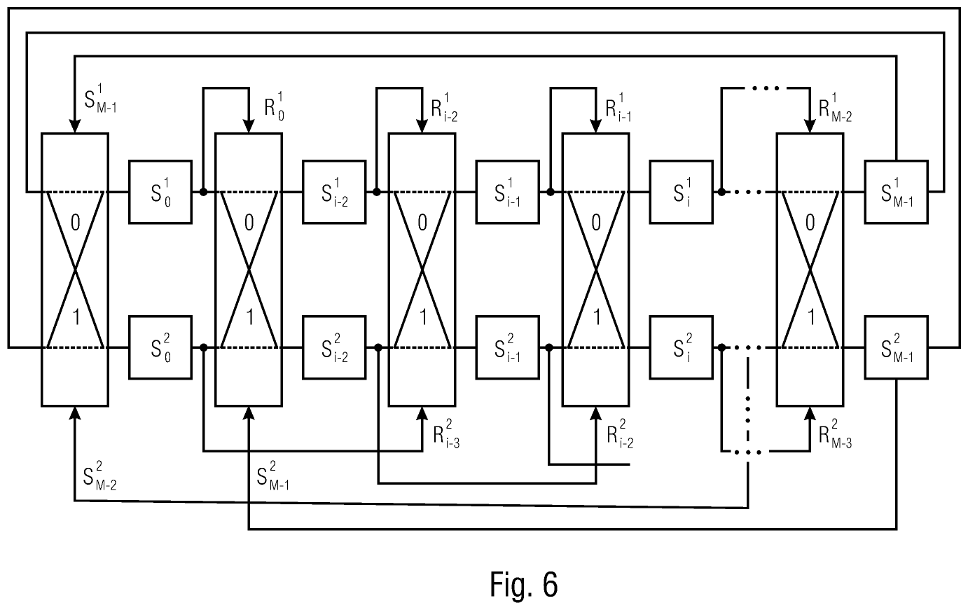

FIG. 5 shows a feedback chain with four portions i=0,1,2,3 each including a chain segment, according to an embodiment. For clarity reasons, only the feedbacks of the first chains are shown.

For the following example, the binary parameters of the first chains are given by

β¹={(β¹₁₀=0, β¹₂₀=0), (β¹₁₁=1, β¹₂₁=1), (β¹₁₂=0, β¹₂₂=1), (β¹₁₃=0, β¹₂₃=1)}

and the parameters of the second chain are given by:

β²={(β²₁₀=1, β²₂₀=0), (β²₁₁=0, β²₂₁=0), (β²₁₂=1, β²₂₂=1), (β²₁₃=1, β²₂₃=0)}.

For an exemplarily selected challenge C=(0, 1, 1, 0) that is applied to both chains, the following values result for the response bits for the two chains:

Determining S¹ⱼ and S²ⱼ for k=0, 1, 2, 3

(S¹₀, S¹₁, S¹₂, S¹₃)=(β¹₁₀=0, β¹₂₁=1, β¹₂₂=1, β¹₁₃=0)

(S²₀, S²₁, S²₂, S²₃)=(β²₁₀=1, β²₂₁=0, β²₂₂=1, β²₁₃=1)

Determining R¹₀ and R²₀

R¹₀=S¹₀=β¹₁₀=0

R²₀=S²₀=β²₁₀=1

Determining R¹₁ and R²₁

R¹₁=S¹₁=β¹₂₁=1

R²₁=S²₁=β²₂₁=0

Determining R¹₂ and R²₂

R¹₂=R₁¹⊕(̅R̅₁̅¹̅⊕̅R̅₀̅²̅)̅S₂¹⊕(R₁¹⊕R₀²)S₂²=1⊕(̅1̅⊕̅1̅)̅1⊕(1⊕1) 1=1⊕1=0

R²₂=R₁²⊕(̅R̅₁̅²̅⊕̅R̅₀̅¹̅)̅S₂²⊕(R₁²⊕R₀¹)S₂¹=0⊕(̅0̅⊕̅0̅)̅1⊕(0⊕0) 1=0⊕1=1

Determining R¹₃ and R²₃ (response bits)

R¹₃=R₂¹⊕(̅R̅₂̅¹̅⊕̅R̅₁̅²̅)̅S₃¹⊕(R₂¹⊕R₁²)S₃²=0⊕(̅0̅⊕̅0̅)̅0⊕(0⊕0) 1=0⊕0=0

R²₃=R₂²⊕(̅R̅₂̅²̅⊕̅R̅₁̅¹̅)̅S₃¹⊕(R₂²⊕R₀¹)S₃¹=1⊕(̅1̅⊕̅1̅)̅1⊕(1⊕1) 0=1⊕1=0

Consequently, the response bits belonging to the challenge C are determined as R¹₃=0 and R²₃=0.

The generic implementations of the above described single chain and the feedback chain fulfil the above requested properties. Proof of this statement is attached to the annex of this document; the indicated proofs are not essential for the construction of the presented strong PUF concept.

The above constructions of the simple and the feedback chain may be understood as elementary components of the concept which fulfil the properties of the strong PUF. For example, modified variations of these components may be used to achieve a higher sensitivity of the response behavior as to changes of the challenge bits and to generate several response bits per chain. The modifications apply for the feedback chain and, where applicable, may be easily transferred to the case of the single chain or several feedback chains. Combinations of the indicated modifications are conceivable.

In embodiments, the challenge sensitivity is increased.

The object of the subsequently-described special embodiments consists in embedding several times into the link of the response bit a challenge or a variation that results from a change of a given challenge. If a challenge bit is changed, this change occurs at several locations of the link so that the influence of the individual challenge bits increases with respect to the response values.

According to coupling variations, one or several chain segments/chain portions may be coupled to other chain segments/portions of the same or a different chain.

In embodiments, alternatively or additionally, one or several chain segments/chain portions may be coupled to parts of the challenge.

In embodiments, alternatively or additionally, one or several challenge bits may be coupled to one another.

According to embodiments, linking several response bits may be provided.

The response bits of different chains may be linked by means of logical operators (XOR, AND, OR, etc.).

Alternatively or additionally, the response bits of one or several chains generated for different challenges may be linked by means of logical operators (XOR, AND, OR, etc.).

In embodiments, challenge variations may be provided.

The above modifications may be performed for different variations of a challenge. In addition, the challenges may be independently varied for different chains. For example, variations of a challenge may be generated by the following operations:

The order in which the challenge bits are arranged may be changed by means of a permutation. In particular, cyclical permutations or rotations of the challenge bits may be used.

Alternatively or additionally, a challenge or part of a challenge may be used as a start value for generating further dependent (pseudo) random challenges, e.g., as a seed for a linear-feedback shift register.

In embodiments, a multi-bit generation is carried out. In order to generate a larger number of response bits per chain, the parity at each chain portion of the feedback chain may be used as response bit. In the case of a feedback chain consisting of a total of N segments divided in M portions, up to 2M response bits may be generated. The maximum number of response bits is 2N, given that each portion includes just one segment.

For the number of chain portions to be the same in the formation of each response bit, the chain may be formed into a ring, for example, by linking the start of the chain and the end of the chain.

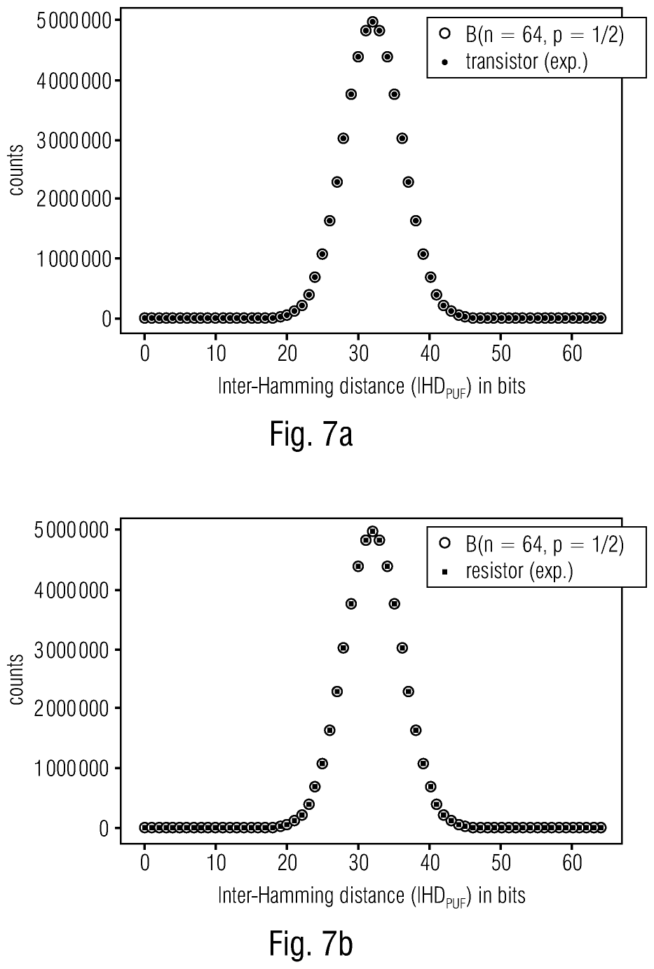

FIG. 6 shows a feedback chain in a ring-shape according to an embodiment. In particular, FIG. 6 shows the ring-shape of a feedback chain with M portions, the feedbacks being only illustrated for the first response bit of the first chain for clarity reasons.

In order to determine the response bit, the equations indicated in section 0 apply, wherein each response bit is to be formed after full passage of the ring. In addition, the periodicity condition S_{i+M}=Sᵢ and S₋ᵢ=S_{M+i} for i=0, 1, 2, . . . , M applies for indexing the M chain portions.

The provided concepts deliver on different hardware primitives improved results with respect to the requested strong PUF properties. The results indicated below illustrate the performance of the provided concepts.

The above-described strong PUF construction according to embodiments, for example, may be implemented for four different PUF primitives that are implemented and produced in different technologies and/or manufacturing lines:

A first PUF primitive is a transistor primitive consisting of 256 digital NMOS transistors manufactured using 350 nm bulk CMOS technology at Fraunhofer IMS. The characteristic quantity of the primitive is the drain voltage of the transistors with an applied constant current and a constantly selected gate voltage. The voltage values of the transistors are read out by means of an integrated ADC.

A second PUF primitive is a poly-resistor primitive consisting of 256 poly-resistors manufactured using 350 nm bulk CMOS technology at Fraunhofer IMS. The voltage drops at the resistors are read out when a current is applied. Readout of the measurement values is carried out by means of an integrated ADC.

A third PUF primitive is a sensor-based primitive including 128 dark pixels of an optical sensor array. The sensor is manufactured using proprietary technology at Fraunhofer IMS. The pixel values are read out with the help of an integrated read out circuit.

A fourth PUF primitive is a ring oscillator primitive implemented on commercially available Xilinx® FPGAs. For the application of the strong PUF construction, the data published in [23] is used. Each data set includes the oscillation frequencies of 512 ring oscillators measured on a FPGA.

The measurement values of the primitives are quantized according to the quantization method in [24] in order to generate stable, random binary keys. The bit values of the generated keys are used as parameters to which the strong PUF construction according to the above embodiments is applied. Each strong PUF instance is designed for challenges with a length of 64 bits and includes 63 feedbacks. 64 randomly generated challenges are used for each strong PUF instance to generate 2×64 response bits. The two response bits for each challenge are linked by means of a XOR operation, resulting in a response with a length of 64 bits.

Applying the quantization method [24] ensures the reproducibility of keys and therefore the stability of all CRPs (see below) which are generated by the strong PUF constructions. If different quantization methods are applied, an error correction of the parameters/response bits is possibly needed before being able to use these as input parameters β for the strong PUF construct.

The randomness and/or uniqueness of the strong PUF CRPs is evaluated based on a standard metric, the inter-Hamming distance (IHD), cf. [2]. It is determined by the average number of bits by which the different CRPs differ on average. Formally, the inter-Hamming distance IHD (R₁, R₂) of two responses R₁ and R₂ with a length of n bits is calculated based on the following equation.

$$IHD ( {R}_{1} , {R}_{2} ) = {Σ}_{i = 1}^{N} {R}_{1}^{i} ⊕ {R}_{2}^{i} ,$$

wherein R₁ⁱ and R₂ⁱ, i=1, 2, . . . , N, designates the i-th bit of the response R₁ and R₂, respectively. The operator ⊕ designates the logical Exclusive Or link of two binary values. The inter-Hamming distance is determined for the responses to different challenge sets of the same PUF instance (IHDPUF) and for the responses to different PUF instances at the same challenge set (IHD_{Challenge}).

For calculating the inter-Hamming distance for different challenges (IHDPUF), the responses of a given PUF instance are calculated for 10,000 randomly generated challenges. In the case of randomly generated response bits, IHDPUF is binomially-distributed B(n=64, p=0.5) with the number of response bits n and the probability p of a response bit corresponding to a logical 1.

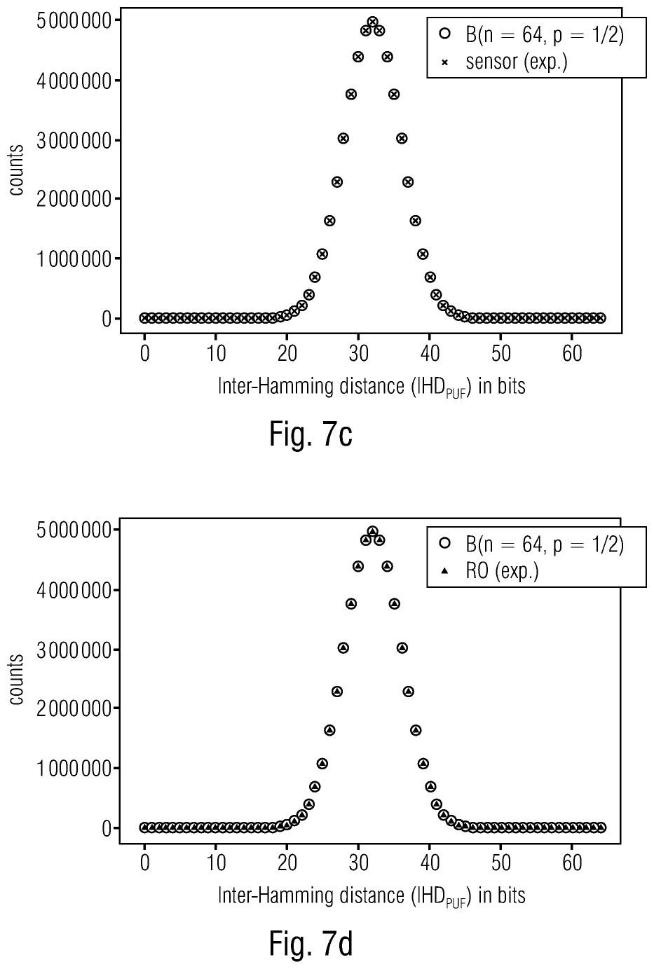

FIG. 7a-FIG. 7d show the distribution of an inter-Hamming distance (IHD_{PUF}) for the four primitives according to embodiments averaged across several PUF instances. In particular, inter-Hamming distances IHD_{PUF} are determined for 10,000 CRPs in FIG. 7a-FIG. 7d. FIG. 7a shows IHD_{PUF} averaged over 33 transistor primitives, FIG. 7b shows IHD_{PUF} averaged over 37 resistor primitives, FIG. 7c shows IHD_{PUF} averaged over 100 sensor primitives and FIG. 7d shows IHD_{PUF} averaged over 100 ring oscillator primitives.

Regardless of the physical system that is used as a primitive, the results correspond to the theoretical limit resulting in the ideal case of random response bits.

The inter-Hamming distance IHD_{Challenge} for different PUF instances is determined for the responses of several PUF instances for a given challenge. In the case of the transistor primitive and resistor primitive, the responses of 33 and 37 PUF instances, respectively, are compared. For the sensor-based primitive and the ring oscillator primitive, the responses of 100 PUF instances are respectively used for determining the IHD_{Challenge}. Ideally, IHD_{PUF} follows a binomial distribution B(n=64, p=0.5) with the number of response bits n and the probability p=0.5 of a response bit corresponding to a logical 1.

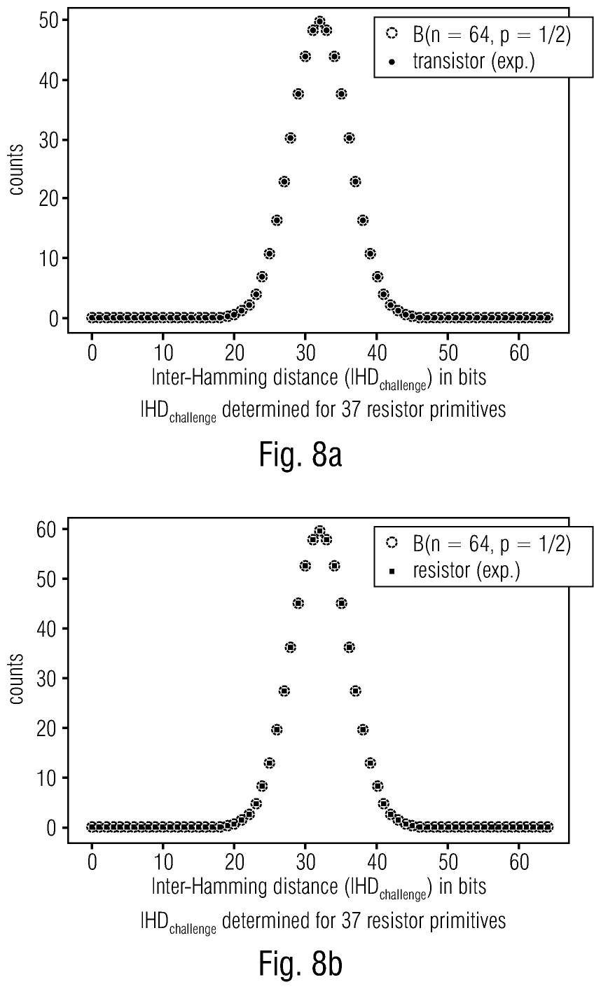

FIG. 8a-FIG. 8d show inter-Hamming distances (IHD_{Challenge}) according to embodiments averaged over 10,000 randomly generated challenges.

In particular, FIG. 8a shows an IHD_{Challenge} determined for 33 transistor primitives, FIG. 8b shows an IHD_{Challenge} determined for 37 resistor primitives, FIG. 8c shows an IHD_{Challenge} determined for 100 sensor primitives and FIG. 8d shows an IHD_{Challenge} determined for 100 ring oscillator primitives.

As can be gathered from the figures, the experimentally determined distributions match the theoretical distribution that arises as a result for the ideal case of randomly generated response bits.

In order to demonstrate the strong dependency of the generated responses on the applied challenge, the strict avalanche criterion was determined for 10,000 randomly generated challenges. For each challenge, a challenge bit is successively varied and the average number of cases in which the response bit of the modified challenge deviates from the response bit of the original challenge is determined. Fulfilling the strict avalanche criterion is given if the response bit varies on average in half of the cases.

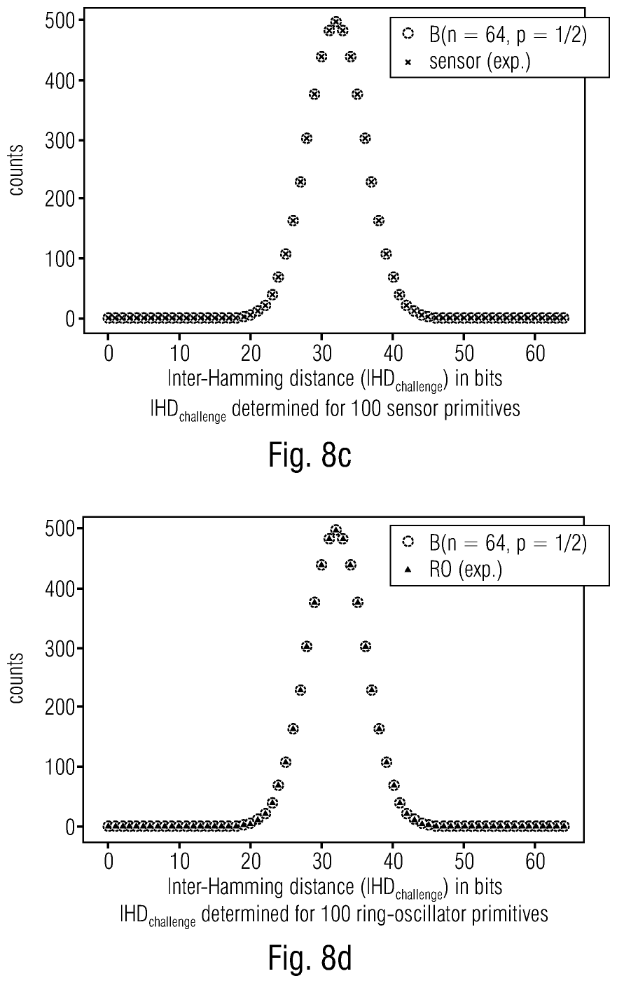

FIG. 9 shows a transition probability determined for 10,000 CRPs according to an embodiment. In particular, FIG. 9 shows the results for four primitive types. On average, the strong PUF construction fulfils the strict avalanche criterion regardless of the selected primitive.

Embodiments realize a non-linear link of binary or signed non-binary parameters of a physical system to generate a device-specific challenge-response behavior. The challenge-response behavior demonstrably fulfils the properties of a strong PUF if the incoming parameters is randomly developed and the sign, or the parity, of the parameters of a realization of the system may be reproducibly measured.

For example, both preconditions are fulfilled by all physical systems which may be used as a weak PUF whose response bits enter into the construction as parameters. When using a weak PUF, similar to the above described requirements, there are the requirements that the weak PUF generates random and reproducible response bits.

Using a weak PUF as a basis of a strong PUF construction has the advantage that the primitive-independent digital correction method (cf. [2], [24]) may be applied to the response of a weak PUF to fulfil the requirements (a) and (b). Using such methods makes it possible to construct strong PUFs which ensure a constantly high performance under different manufacturing conditions (technology nodes, manufacturing line, etc.) for any system (see above). This type of system independence is characterized in that different weak PUF designs, such as SRAM PUFs or ring oscillator PUFs, using different physical effects for the response generation may be used consistently for the construction of a strong PUF. The situation is different for existing strong PUF constructions whose vast majority uses variations in the grid run time to generate responses. As the findings in [2] have shown, the performance of the PUF design depends in part strongly on the chosen implementation form. Since the bit generation is performed from analog quantities, it is not possible to apply digital correction methods to the parameters.

A further advantage of the presented strong PUF construction is the non-linear dependency of the response on the incoming parameters and the applied challenge. The number of the non-linear elements given by the feedbacks of the parameters may be easily varied to achieve a desired resistance against modelling attacks in the context of the PAC model (section 0). In contrast, [5] and [11] show that the implementable XOR arbiter-based strong PUF constructions are PAC learnable. According to the theoretical considerations in [13], this also applies to the family of the bistable-ring PUFs.

The most important advantages of the solution concepts presented may be summarized as follows, wherein one or several of the subsequently described advantages may be realized in embodiments:

For example, the construction may consist of elementary logic gates.

For example, strong PUF properties may be demonstrably fulfilled (cf. annex). The theoretical considerations were verified based on an experimental measurement on different systems implemented in different technologies.

For example, the concepts may provide a strong PUF functionality for all weak PUF designs.

For example, the concepts may be used regardless of the system.

For example, a scalable, non-linear response generation may provide an increased protection against modelling attacks.

For example, the generation of several bits per chain may be possible.

For example, the strong PUF construction may be used complimentary to the IMS weak PUF concept [24]: For example, the combination of both concepts may enable the construction of strong PUFs on the basis of any components which ensure a high security level with respect to randomness and uniqueness of the CRPs.

Embodiments for generating random challenge-response pairs are provided.

Provided is a construction including linage of a multitude of, e.g., physically measureable, parameters to generate one or several random binary sequences which depend on the values of the parameters. Subsequently, the sequence generated by the construction is referred to as response.

The parameters may include binary or signed non-binary values which may correspond to measureable physical parameters of a system or to the values of a random generator. In the case of a physical system, for example, these may be the state values of logic gates or memory elements such as SRAM or flash. In the case of non-binary parameters, difference values of parameters are possible (voltage differences, current differences, difference in the oscillation frequencies of ring oscillators, etc.).

For example, the parameters that are linked for generating a response may be selectable according to an instruction stored in the construction or externally specified.

For example, an instruction that determines the parameters to be linked is subsequently referred to challenge.

A link may include the application of mathematical or logical operators or functions that may be implemented on the hardware side or on the software side. In the case of binary parameters, a link may be realized by means of XOR operators, for example. Signed non-binary parameters may be multiplicatively linked.

For example, concrete functions are the above-described constructions of the single and the feedback chain. For example, these elementary constructions may be modified according to the above-described variations.

For example, the challenge-response pairs that may be combined from a challenge and the associated response may be used for identifying or authenticating an instance of this construction.

Embodiments refer to manufacturing strong PUFs whose challenge-response behavior comprises a high level of randomness, uniqueness and stability regardless of the primitive used.

Subsequently, properties of the strong PUF constructions according to embodiments are described or proven.

The following sections show that an implementation of the above-described single chain and the above-described feedback chain may fulfil the above-requested properties. In an embodiment, the parameters β of the chains may be binary, for example.

First, the property of the randomness is considered.

If the parameters of a construction are distributed independently and identically uniformly, the following applies: the response bits of different PUF instances are distributed for an arbitrary, fixed challenge, i.e., the response bits of a randomly selected PUF instance correspond to a logical 1 with a probability of 0.5.

In addition, if the parameters of a construction are distributed independently and identically uniformly, the response bits of any PUF instance are uniformly distributed to various randomly selected challenges.

Below is the proof for the uniform distribution of the response bits of different PUF instances for any fixed challenge:

In the case of a single chain consisting of N segments, the probability P(R=1) of obtaining a logical 1 as a response bit may be determined as follows:

The probability P(sₖ=1) of the k-th chain segment sₖ giving a logical 1 is as follows:

$$\begin{matrix}P ( {s}_{k} = 1 ) = ( 1 - {c}_{k} ) P ( {β}_{1 k} = 1 ) + {c}_{k} P ( {β}_{2 k} = 1 ) \\ = ( 1 - {c}_{k} ) \frac{1}{2} + {c}_{k} \frac{1}{2} \\ = \frac{1}{2}\end{matrix}$$

wherein the prerequisite that β₁ₖ and β₂ₖ are uniformly distributed, i.e., P(β₁ₖ)=P(β₂ₖ)=0,5 applies, is used in the second line.

The value of the response bit is determined by the parity of the linked chain segments. Consequently, the probability P(R=1) is equal to the probability of totality of the chain segments comprising an odd number of ones:

$$\begin{matrix}P ( R = 1 ) = {\sum }_{k = 0}^{N} ( \begin{matrix}N \\ 2 k + 1\end{matrix} ) {P ( {s}_{k} = 1 )}^{2 k + 1} {( 1 - P ( {s}_{k} = 1 ) )}^{N - ( 2 k + 1 )} \\ = {\sum }_{k = 0}^{N} ( \begin{matrix}N \\ 2 k + 1\end{matrix} ) \frac{1}{{2}^{N}} \\ = {2}^{N - 1} \frac{1}{{2}^{N}} \\ = \frac{1}{2}\end{matrix}$$

wherein the following identity has been used in the transition of the second to the third line. cf. [20]:

$${\sum }_{k = 0}^{N} ( \begin{matrix}N \\ 2 k + 1\end{matrix} ) = {2}^{N - 1}$$

In the case of the feedback chain, the proof is done by means of induction. A feedback chain consisting of L portions is given, wherein each portion is combined from a single chain with N segments designates the response bit which results after the passage of the j-th chain after the l-th chain portion. According to the above proof for the single chain, the response bits R^{j}₀ and R^{j}₁ of the feedback chain are uniformly distributed per construction if the parameters of the zeroth and first chain portions of the two chains are uniformly distributed. The assumption that the response bits of the first and second chain are uniformly distributed applies for R¹_{I-1} and R²_{I-1}. For the probability P(R¹_{I}=1) of the I-th response bit of the first chain being a logical 1, the following applies:

$$\begin{matrix}P ( {R}_{1}^{1} = 1 ) = P ( {R}_{l - 1}^{1} ⊕ {S}_{l}^{1} = 1 ) P ( {R}_{l - 1}^{1} ⊕ {R}_{l - 2}^{2} = 0 ) + \\ P ( {R}_{l - 1}^{1} ⊕ {S}_{l}^{2} = 1 ) P ( {R}_{l - 1}^{1} ⊕ {R}_{l - 2}^{2} = 1 ) \\ = [ P ( {R}_{l - 1}^{1} = 1 ) P ( {S}_{l}^{1} = 0 ) + P ( {R}_{l - 1}^{1} = 0 ) P ( {S}_{l}^{1} = 1 ) ] \\ P ( {R}_{l - 1}^{1} ⊕ {R}_{l - 2}^{2} = 0 ) + \\ [ P ( {R}_{l - 1}^{1} = 1 ) P ( {S}_{l}^{2} = 0 ) + P ( {R}_{l - 1}^{1} = 0 ) P ( {S}_{l}^{2} = 1 ) ] \\ P ( {R}_{l - 1}^{1} ⊕ {R}_{l - 2}^{2} = 0 ) \\ = \frac{1}{2} [ P ( {S}_{l}^{1} = 0 ) + P ( {S}_{l}^{1} = 1 ) ] P ( {R}_{l - 1}^{1} ⊕ {R}_{l - 2}^{2} = 0 ) + \\ \frac{1}{2} [ P ( {S}_{l}^{2} = 0 ) + P ( {S}_{l}^{2} = 1 ) ] P ( {R}_{l - 1}^{1} ⊕ {R}_{l - 2}^{2} = 1 ) \\ = \frac{1}{2} [ P ( {R}_{l - 1}^{1} ⊕ {R}_{l - 2}^{2} = 0 ) + P ( {R}_{l - 1}^{1} ⊕ {R}_{l - 2}^{2} = 1 ) ] \\ = \frac{1}{2}\end{matrix}$$

wherein the induction assumption was used in the third line. In lines four and five, respectively, the following identities were used:

1=P(Sₗ^{j}=0)+P(Sₗ^{j}=1)

1=P(Rₗ₋₁¹⊕Rₗ₋₂²=0)+P(Rₗ₋₁¹⊕Rₗ₋₂²=1)

The proof for the response bit R²1 of the second chain is performed analogously.

The following illustrates the proof for the uniform distribution of the challenge bits of any PUF instance at different randomly selected challenges:

The probability P(R=1) of a single chain with N segments providing the response value 1 for a randomly selected challenge is equal to the probability P(X=“odd”) that an odd number of segments assumes a logical 1.

The probability P(sₖ=1) of the k-th chain segment corresponding to a logical 1 generally depends on the values of the parameters β₁ₖ, β₂ₖ and the probability P(cₖ=1) with which the k-th challenge bit is a logical 1:
1. β₁ₖ=0 and β₂ₖ=1: P(sₖ=1)=P(cₖ=1), subsequently referred to as p₀₁
2. β₁ₖ=1 and β₂ₖ=0: P(sₖ=1)=1−P(cₖ=1), subsequently referred to as p₁₀
3. β₁ₖ=1 and β₂ₖ=1: P(sₖ=1)=1, subsequently referred to as p₁₁
4. β₁ₖ=0 and β₂ₖ=0: P(sₖ=1)=0, subsequently referred to as p₀₀

In the case of randomly generated challenges, the value of each challenge bit is uniformly distributed, i.e., P(cₖ=1)=0.5. If one of the parameters is a logical 1, consequently, p₀₁=p₁₀=0.5 applies.

Due to the different probabilities p₀₁≠p₁₁≠p₀₀, the number q of the N chain segments with the value 1 follows a generalized binomial distribution:

$$P ( X = q ) = {\sum }_{A ∈ {B}_{q}} {\prod }_{i ∈ A} {p}_{i} {\prod }_{j ∈ {A}^{c}} ( 1 - {p}_{j} )$$

wherein B_{q} designates the set of all q-element subsets of set {1, 2, 3, . . . , N}. A^{c} designates the complement of set A. The probabilities pₘ, with m=1, 2, 3, . . . N, are elements of the N tuple p=(p₀₁ 1ₙ₀₁, p₁₁ 1ₙ₁₁, p₀₀ 1ₙ₀₀). In this case, 1ₗ denotes the unit vector of the length l. Thus, the following applies for the probability P(R=1):

$$P ( R = 1 ) = P ( X = “ odd ” ) = {\sum }_{A ∈ {B}_{q} \\ q = “ o d d ”} {\prod }_{i ∈ A} {p}_{i} {\prod }_{j ∈ {A}^{c}} ( 1 - {p}_{j} )$$

The frequencies n₀₁, n₁₁ and n₀₀ according to which the respective probabilities p₀₁, p₁₁ and p₀₀ are present in p, follow a multinomial distribution in the case of uniformly distributed parameters [21]:

$$P ( {X}_{n 01} = {n}_{01} , {X}_{n 11} = {n}_{11} , {X}_{n 00} = {n}_{00} ) = \frac{N !}{{n}_{01} ! \cdot {n}_{11} ! \cdot {n}_{00} !} {p}_{1}^{{n}_{01}} \cdot {p}_{2}^{{n}_{11}} \cdot {p}_{3}^{{n}_{00}}$$

wherein p₁ designates the probability of one of the two parameters of a chain segment being a logical 1. Analogously, p₂ and p₃ are the probabilities of the two parameters being a logical 1 and that two parameters being a logical 0, respectively. In the case of uniformly distributed parameters, the probabilities p₁, p₂ and p₃ are given by:

$${p}_{1} = P ( {β}_{1 k} = 0 ) P ( {β}_{2 k} = 1 ) + P ( {β}_{1 k} = 1 ) P ( {β}_{2 k} = 0 ) = \frac{1}{2} \cdot \frac{1}{2} + \frac{1}{2} \cdot \frac{1}{2} = \frac{1}{2}$$

$${p}_{2} = P ( {β}_{1 k} = 1 ) P ( {β}_{2 k} = 1 ) = \frac{1}{2} \cdot \frac{1}{2} = \frac{1}{4}$$

$${p}_{3} = P ( {β}_{1 k} = 0 ) P ( {β}_{2 k} = 0 ) = \frac{1}{2} \cdot \frac{1}{2} = \frac{1}{4}$$

for each chain segment k=1, 2, 3, . . . , N.

According to the above discussion, the probability P of the values of the response bits of an N-segmented chain being uniformly distributed for a random set of parameters with a random challenge selection may be determined.

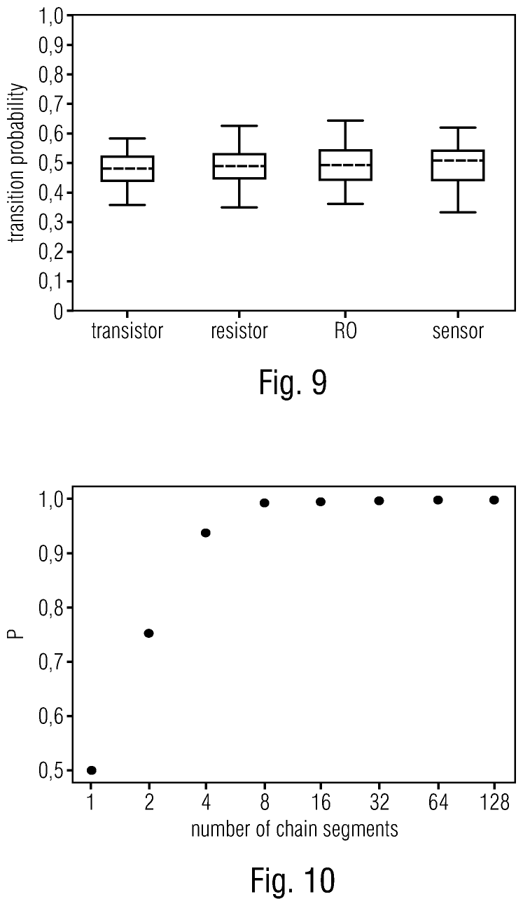

FIG. 10 shows a probability P depending on the chain length according to an embodiment. In particular, FIG. 10 illustrates P depending on the number of the chain segments N.

As can be gathered from the figure, the response bits of the single chain having 16 or more segments are uniformly distributed with the probability P≈1, i.e., each of these chains generates random response bit values for randomly selected challenges.

In the case of the feedback chain, the statement is proven by means of complete induction, analogously to the proof in the previous section. After passage of one or several portions with a total number of at least 16 segments, the values of the response bits of each feedback chain are uniformly distributed since, with respect to the structure, the intermixture of two or several chains results in a single chain. r denotes the portion number for which the overall number of the segments is 16 or more. The induction requirement is fulfilled for the response bits R¹ₗ₋₁ and R²ₗ₋₁ with l−1≥r. The step of l−1 after l is identical to the above-stated induction proof.

The CRPs of the strong PUF constructions are unique if the generation of the response bits is performed randomly. This may be proven as follows:

The probability P(R^{k}ₘ≠R^{l}ₘ) of the m-th response bit of two arbitrary n-bit long responses R^{k} and R^{l} differing is as follows:

$$\begin{matrix}P ( {R}_{m}^{k} \neq {R}_{m}^{l} ) = P ( {R}_{m}^{k} = 1 ) P ( {R}_{m}^{l} = 0 ) + P ( {R}_{m}^{k} = 0 ) P ( {R}_{m}^{l} = 1 ) \\ = \frac{1}{2} \cdot \frac{1}{2} + \frac{1}{2} \cdot \frac{1}{2} \\ = \frac{1}{2}\end{matrix}$$

wherein the second equal symbol applies in the case that the values of the response bits are uniformly distributed. In this case, the above equation is fulfilled for all response bits, i.e., pᵤ=P(R^{k}ₘ=R^{l}ₘ)=0.5 for all m. Consequently, the number q of response bits in which R^{k} and R^{l} differ is binomially distributed. The probability P(X=q) of any two n-bit long responses R^{k} and R^{l} differing in exactly q response bits is given by:

$$\begin{matrix}P ( X = q ) = ( \begin{matrix}n \\ q\end{matrix} ) {{p}_{u}^{q} ( 1 - {p}_{u} )}^{n - q} \\ = ( \begin{matrix}n \\ q\end{matrix} ) \frac{1}{{2}^{n}}\end{matrix}$$

The expected value is E[X]=n·pᵤ=n/2, i.e., two responses differ on average in half of the response bits.

Since the generation of the response bits of different PUF instances is random for any fixed challenge, the response-bits of different PUF instances are unique for each given challenge. In addition, the values of the response bits of a PUF instance which are generated for randomly selected challenges are uniformly distributed, which is why the CRPs of each given PUF instance are also unique.

For any challenge, the stability of the generated response bits depends exclusively on the stability of the sign and/or the parity of the incoming parameters β. If reproducibility of the sign and/or the parity may be ensured for certain operation conditions, e.g., by using error correction methods, the response bits of the construction are also reproducible for the same operation conditions.

Since the feedback construction is made from single chains in portions, the response bits may be reproduced exactly if all chain portions provide reproducible parity values. This is the case if the parameters of the two chains comprise stable signs and/or parity values.

With regard to the strict avalanche criterion, it may be stated that, in the case of uniformly distributed parameters β, the mean probability P_{Trans} of the value of the response bit varying when changing a challenge bit is 50%. Consequently, the realizations of the described strong PUF constructions fulfil the strict avalanche criterion on average. This may be proven as follows:

In the case of a single chain consisting of N segments which comprises exactly k segments whose parameters differ in value (e.g., β₁ₗ=0 and β₂ₗ=1 or β₁ₖ=1 and β₂ₖ=0 for the l-th chain segment), the change probability P_{Trans}=k/N. The probability P_{Instance}(X=k) of a randomly selected chain including exactly k of such segments is given for independently and identically distributed parameters by the probability function of a binomial distribution B(N,p):

$${P}_{instance} ( X = k ) = ( \begin{matrix}N \\ k\end{matrix} ) {{p}^{k} ( 1 - p )}^{N - k}$$

With the probability p=P(β₁ₗ⊕β₁ₗ=1) of the parameters differing in any segment l=1, 2, 3 . . . , N of the chain. p=0.5 applies for uniformly distributed parameters.

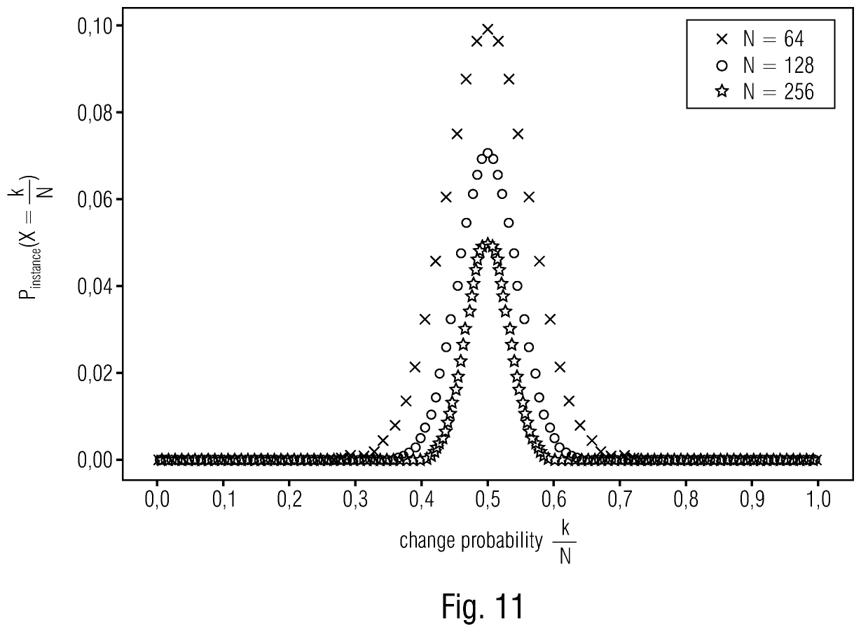

FIG. 11 shows a probability distribution P_{Instanz}(X=k/N) of single chains of the lengths N=64, 128, 256 according to an embodiment. FIG. 11 shows the probability distribution P_{instance}(Y=k/N) that any realization of a single chain has a variation probability k/N when changing of a challenge bit, for the case of uniformly distributed parameters. Illustrated are the distributions for the chain lengths N=64, 128, 256.

The expected value E[Y=k/N] and the variance Var[Y=k/N] are given by the following equations:

E[Y=k/N]=E[X/N]=E[X]/N=Np/N=p=0.5

Var[Y=k/N]=Var[X/N]=Var[X]/N²=Np(1−p)/N²=0.25/N

using the fact that the random variable X is binomially distributed. The respective last equal symbol applies in the case of uniformly distributed parameters. Consequently, regardless of the chain length, the variation probability is on average 50%, quod erat demonstrandum. The deviation from the strict avalanche criterion measured in the standard deviation

$$s = \sqrt{Var [ Y ]}$$

decreases inversely proportional to the root of the chain length N.

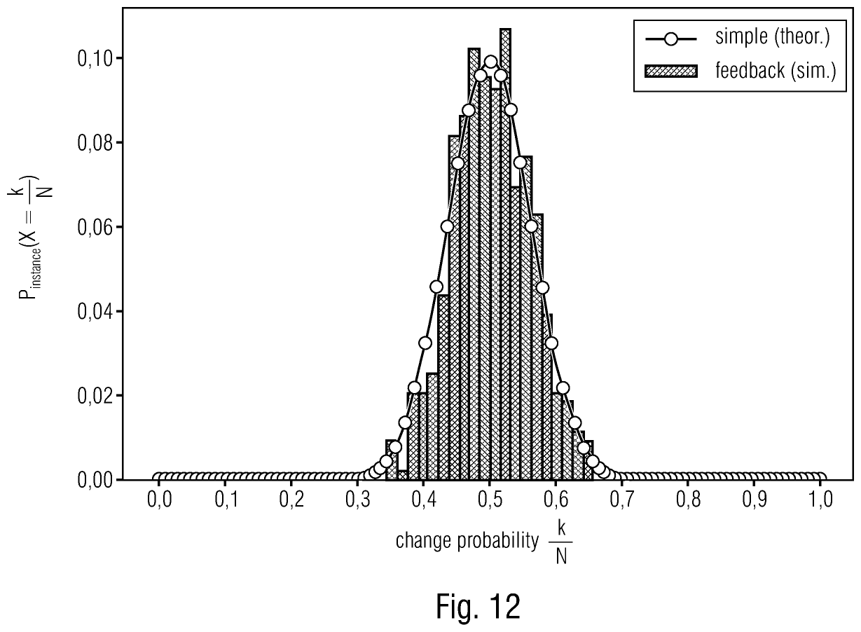

In the case of a feedback chain, the distribution of the variation probability was determined by means of the Monte-Carlo simulation. For this purpose, 430 feedback chains consisting of 64 chain segments each were simulated. The values of the parameters of the respective chains were taken from the discrete equal distribution U(0,1). For each chain, the variation probability of the response bit when changing a challenge bit was determined for 10,000 randomly generated challenges. The resulting distribution is illustrated in FIG. 12.

Thus, FIG. 12 shows a probability distribution P Instanz(X=k/N) of the feedback and of a single chain (N=64) according to an embodiment.

The mean variation probability is 0.501 at a standard deviation of 0.059. On average, the realization of the feedback chain fulfils the strict avalanche criterion.

With respect to the resistance against modelling attacks, the equation for calculating the response bit of a feedback chain with n segments and k<n feedbacks may be written as a ring-sum expansion RSE:

Rₗ¹=Rₗ₋₁¹⊕Sₗ¹(Rₗ₋₁¹⊕Rᵢ₋₂²)(Sₗ¹⊕Sₗ²)

Rₗ²=Rₗ₋₁²⊕Sₗ²(Rₗ₋₁²⊕Rᵢ₋₁²)(Sₗ²⊕Sₗ¹)

Due to the k feedbacks, terms with monomials S₁S₂ . . . Sₗ up to the length k+1 arise in the equation. Consequently, the equation for determining the response bit corresponds to a (k+1) RSE. According to [22], at least:

$$m ( δ , ɛ , C ) = O ( \frac{1}{ɛ} log \frac{1}{δ} + \frac{{p}^{k + 1}}{ɛ} )$$

training samples are needed for the model generation of a (k+1) RSE with p parameters in the context of PAC learning. Accordingly, in the case of a multi-feedback chain, a large number of training samples of O(n^{k+1}) is needed. Since at least O(10⁵⁴) CRPs are needed for creating a model in typical realizations of the constructions with design parameters n≥64 and k≤30 (e.g., a 64 bit challenge strong PUF with 30 feedbacks), modelling attacks may be practically not be performed due to the finite readout speed of a challenge-response pair.

For a construction without feedbacks (k=0), the number of the training samples scales linearly with the number of the chain segments. In this case, the resistance against modelling attacks is comparable to that of a simple arbiter PUF. Consequently, the feedback construction should therefore be used for safety-critical applications.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described within the context of or as a method step also represent a description of a corresponding block or detail or feature of a corresponding device. Some or all of the method steps may be performed while using a hardware device, such as a microprocessor, a programmable computer or an electronic circuit. In some embodiments, some or several of the most important method steps may be performed by such a device.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described herein, said computer program being stored on a machine-readable carrier. In other words, an embodiment of the inventive method thus is a computer program which has a program code for performing any of the methods described herein, when the computer program runs on a computer.

A further embodiment of the inventive methods thus is a data carrier (or a digital storage medium or a computer-readable medium) on which the computer program for performing any of the methods described herein is recorded. The data carrier, the digital storage medium, or the recorded medium are typically tangible, or non-volatile.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing unit, for example a computer or a programmable logic device, configured or adapted to perform any of the methods described herein.

A further embodiment includes a computer on which the computer program for performing any of the methods described herein is installed.

A further embodiment in accordance with the invention includes a device or a system configured to transmit a computer program for performing at least one of the methods described herein to a receiver. The transmission may be electronic or optical, for example. The receiver may be a computer, a mobile device, a memory device or a similar device, for example. The device or the system may include a file server for transmitting the computer program to the receiver, for example.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware device. Said hardware device may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### BIBLIOGRAPHY

[1] C. Herder, M.-D. Yu, F. Koushanfar, and S. Devadas, “Physical Unclonable Functions and Applications: A Tutorial,” Proc. IEEE, vol. 102, no. 8, pp. 1126-1141, August 2014.
[2] M. Roel, “Physically unclonable functions: Constructions, properties and applications,” Diss. Univ. KU Leuven, 2012.
[3] M. Majzoobi, F. Koushanfar, and M. Potkonjak, “Lightweight secure pufs,” in Computer-Aided Design, 2008. ICCAD 2008. IEEE/ACM International Conference on, 2008, pp. 670-673.
[4] “Lawineneffekt (Kryptographie),” Wikipedia. 13 Dec. 2016.
[5] M. Conti, M. Schunter, and I. Askoxylakis, Eds., Trust and Trustworthy Computing, vol. 9229. Cham: Springer International Publishing, 2015.
[6] A. Ehrenfeucht, D. Haussler, M. Kearns, and L. Valiant, “A general lower bound on the number of examples needed for learning,” Inf. Comput., vol. 82, no. 3, pp. 247-261, 1989.
[7] B. Gassend, D. Clarke, M. Van Dijk, and S. Devadas, “Silicon physical random functions,” in Proceedings of the 9th ACM conference on Computer and communications security, 2002, pp. 148-160.
[8] U. Rührmair, F. Sehnke, J. Salter, G. Dror, S. Devadas, and J. Schmidhuber, “Modeling attacks on physical unclonable functions,” in Proceedings of the 17th ACM conference on Computer and communications security, 2010, pp. 237-249.
[9] G. E. Suh and S. Devadas, “Physical unclonable functions for device authentication and secret key generation,” in Proceedings of the 44th annual design automation conference, 2007, pp. 9-14.
[10] C. Zhou, K. K. Parhi, and C. H. Kim, “Secure and Reliable XOR Arbiter PUF Design: An Experimental Study based on 1 Trillion Challenge Response Pair Measurements,” 2017, pp. 1-6.
[11] G. T. Becker, “The gap between promise and reality: On the insecurity of XOR arbiter PUFs,” in International Workshop on Cryptographic Hardware and Embedded Systems, 2015, pp. 535-555.
[12] Q. Chen, G. Csaba, P. Lugli, U. Schlichtmann, and U. Rührmair, “The bistable-ring puf: A new architecture for strong physical unclonable functions,” in Hardware-Oriented Security and Trust (HOST), 2011 IEEE International Symposium on, 2011, pp. 134-141.
[13] F. Ganji, S. Tajik, F. Fä\s sler, and J.-P. Seifert, “Strong machine learning attack against PUFs with no mathematical model,” in International Conference on Cryptographic Hardware and Embedded Systems, 2016, pp. 391-411.
[14] D. Yamamoto, M. Takenaka, K. Sakiyama, and N. Torii, “Security evaluation of bistable-ring PUFs on FPGAs using differential and linear analysis,” in Computer Science and Information Systems (FedCSIS), 2014 Federated Conference on, 2014, pp. 911-918.
[15] X. Xu, U. Rührmair, D. E. Holcomb, and W. Burleson, “Security evaluation and enhancement of bistable-ring PUFs,” in International Workshop on Radio Frequency Identification: Security and Privacy Issues, 2015, pp. 3-16.
[16] R. Kumar and W. Burleson, “On design of a highly secure PUF based on non-linear current mirrors,” in Hardware-Oriented Security and Trust (HOST), 2014 IEEE International Symposium on, 2014, pp. 38-43.
[17] Q. Guo, J. Ye, Y. Gong, Y. Hu, and X. Li, “Efficient Attack on Non-linear Current Mirror PUF with Genetic Algorithm,” 2016, pp. 49-54.
[18] M.-D. M. Yu and S. Devadas, “Recombination of physical unclonable functions,” 2010.
[19] A. Maiti, I. Kim, and P. Schaumont, “A Robust Physical Unclonable Function With Enhanced Challenge-Response Set,” IEEE Trans. Inf. Forensics Secur., vol. 7, no. 1, pp. 333-345, February 2012.
[20] “Sum of Odd Index Binomial Coefficients—ProofWiki,” 13 Dec. 2017. [Online]. Available: https://proofwiki.org/wiki/Sum_of_Odd_Index_Binomial_Coefficients. [Accessed: 13 Dec. 2017].
[21] “Multinomialverteilung,” Wikipedia. 8 Feb. 2017.
[22] A. Blum and M. Singh, “Learning Functions of k Terms.,” in COLT, 1990, pp. 144-153.
[23] A. Maiti, J. Casarona, L. McHale, and P. Schaumont, “A large scale characterization of RO-PUF,” in Hardware-Oriented Security and Trust (HOST), 2010 IEEE International Symposium on, 2010, pp. 94-99.
[24] German patent application 10 2017 215 619.8, Application date: Sep. 5, 2017.
[25] https://staff.aist.go.jp/hori.y/en/puf/index.html

1. An apparatus for determining one or several response bits, the apparatus comprising:
a hardware element comprising a plurality of parameters, and
a determination module for determining one or several response bits, wherein the determination module is configured to perform the determination of each response bit of the one or several response bits depending on one or several challenge bits,
wherein the determination module is configured to determine each of the one or several response bits by means of one or several selection processes, wherein the determination module is configured to, in each selection process of the one or several selection processes, perform a selection of a parameter from two or several parameters of the plurality of parameters of the hardware element, wherein the determination module is configured to perform the selection of the parameter from the two or several parameters depending on a challenge bit of the one or several challenge bits.

2. The apparatus according to claim 1,
wherein each parameter of the plurality of parameters of the hardware element is a physically measurable quantity or was determined from a physically measurable quantity.

3. The apparatus according to claim 1, wherein at least one of the plurality of parameters depends on an electrical voltage or on an electrical current in the hardware element or from an oscillation cycle of the oscillator in the hardware element.

4. The apparatus according to claim 1,
wherein the determination module is configured to perform the determination of each response bit of the one or several response bits depending on two or several challenge bits,
wherein the determination module is configured to determine each of the one or several response bits by means of two or several selection processes, wherein the determination module is configured to, in each selection process of the two or several selection processes, perform the selection of the parameter from two or several parameters of the plurality of parameters of the hardware element, wherein the determination module is configured to perform the selection of the parameter from the two or several parameters depending on a challenge bit of the two or several challenge bits.

5. The apparatus according to claim 4,
wherein the determination module is configured to perform the selection of the parameter from the two or several parameters such that each selection process of the two or several selection processes depends on a different challenge bit of the two or several challenge bits.

6. The apparatus according to claim 4,
wherein each parameter of the plurality of parameters is present as a binary value, and
wherein the determination module is configured to determine each response bit of the one or several response bits by means of the two or several selection processes such that the binary values of the two or several parameters that were determined in the two or several selection processes are linked by means of an XOR link in order to acquire the response bit.

7. The apparatus according to claim 4,
wherein each parameter of the plurality of parameters is present as a numerical value, wherein the determination module is configured to determine to each numerical value of each parameter of the plurality of parameters a binary value for the parameter by means of a comparison to a threshold value of a plurality of threshold values,
wherein the determination module is configured to determine each response bit of the one or several response bits by means of the two or several selection processes such that the binary values of the two or several parameters determined in the two or several selection processes are linked to each other by means of a XOR link in order to acquire the response bit.

8. The apparatus according to claim 6,
wherein the determination module is configured to determine each response bit of the one or several response bits by means of the two or several selection processes using the following equation:
$$R = {⊕}_{k = 0}^{N} ( {\overline{c}}_{k} {β}_{1 k} ⊕ {c}_{k} {β}_{2 k} )$$
wherein R refers to the response bit or an intermediate result for determining the response bit,
wherein N refers to a number of the two or several selection processes,
wherein Cₖ is a binary value of a challenge bit of the two or several challenge bits on which a k-th selection process of the two or several selection processes depends,
wherein c̅ₖ is a negated value of the challenged bit of two or several challenge bits on which the k-th selection process of the two or several selection processes depends,
wherein β₁ₖ is the binary value of a first parameter of the two or several parameters, and
wherein β₂ₖ is the binary value of a second parameter of the two or several parameters.

9. The apparatus according to claim 4,
wherein each parameter of the plurality of parameters is present as a numerical value, and
wherein the determination module is configured to determine each response bit of the one or several response bits by means of the two or several selection processes such that two or several parameters determined in the two or several selection processes are multiplied with each other in order to acquire an intermediate result, wherein the determination module is configured to compare the intermediate result to a threshold value in order to determine the response bit.

10. The apparatus according to claim 4,
wherein the determination module is configured to determine the one or several response bits depending on two or more chains, wherein each of the two or more chains comprises two or more chain segments, wherein each of the two or more chain segments of each of the two or more chains is assigned to exactly one selection process of the two or more chains, wherein each chain segment of the two or more chains respectively comprises two or more parameters of the plurality of parameters of the hardware element,
wherein the determination module is configured to determine each of the one or several response bits by means of the two or several selection processes such that the determination module is configured to, in each selection process of the two or several selection processes, select one chain of the two or more chains, wherein the determination module is configured to determine the chain segment of the selected chain that is assigned to the selection process, and wherein the determination module is configured to determine the response bit by selecting a parameter of the two or more parameters of the chain segment assigned to the selection process depending on the challenge bit of the two or several challenge bits

11. The apparatus according to claim 10,
wherein the determination module is configured to determine each of the one or several response bits by means of the two or several selection processes such that the two or several selection processes follow each other,
wherein the determination module is configured to, in a current selection process of the two or several selection processes, determine the chain from the two or several chains depending on a selection process preceding the current selection process.

12. The apparatus according to claim 1,
wherein the determination module is configured for determining two or several response bits.

13. The apparatus according to claim 1,
wherein the hardware element is a transistor.

14. The apparatus according to claim 1,
wherein the hardware element is a resistor.

15. The apparatus according to claim 1,
wherein the hardware element is an optical sensor.

16. The apparatus according to claim 1,
wherein the hardware element is a reprogrammable circuit.

17. A method for determining one or several response bits, wherein the method comprises:
determining one or several response bits, wherein the determination of each response bit of the one or several response bits is performed depending on one or several challenge bits,
wherein each of the one or several response bits is determined by one or several selection processes, wherein, in each selection process of the one or several selection processes, a selection of a parameter is performed from two or several parameters of the plurality of parameters of a hardware element, wherein the selection of the parameter from the two or several parameters is performed depending on a challenge bit of the one or several challenge bits.

18. A non-transitory digital storage medium having a computer program stored thereon to perform the method for determining one or several response bits, wherein the method comprises:
determining one or several response bits, wherein the determination of each response bit of the one or several response bits is performed depending on one or several challenge bits,
wherein each of the one or several response bits is determined by one or several selection processes, wherein, in each selection process of the one or several selection processes, a selection of a parameter is performed from two or several parameters of the plurality of parameters of a hardware element, wherein the selection of the parameter from the two or several parameters is performed depending on a challenge bit of the one or several challenge bits,
when said computer program is run by a computer.
